(19) United States
(12) Patent Application Publication
(10) Pub. No.: US 2026/0204156 A1
(43) Pub. Date: Jul. 16, 2026

(54) FLASH PROGRAM BLOCK AND RELATED SYSTEM

(71) Applicant: SWARCO McCain Inc., Vista, CA (US)

(72) Inventors: Reza Roozitalab, Vista, CA (US); Jimi Meshulam, Vista, CA (US); Alejandro Landeros, Vista, CA (US); Ernesto Osuna, Vista, CA (US); Frederick Sim, Vista, CA (US); Luis Baez, Vista, CA (US)

(73) Assignee: SWARCO McCain Inc., Vista, CA (US)

(21) Appl. No.: 19/447,361

(22) Filed: Jan. 13, 2026

Related U.S. Application Data
(60) Provisional application No. 63/745,311, filed on Jan. 14, 2025.

(51) Int. Cl. G08G 1/07

(52) U.S. Cl. CPC G08G 1/07

(57) ABSTRACT

An improved flash program block and related system for a traffic signal cabinet are disclosed. The flash program block includes a planar substrate having a top surface, a bottom surface, and edges including a top edge and a bottom edge. One or more tabs extend from the bottom edge, each carrying conductive traces. A mode indicator on the top edge visually identifies a specific flash mode, such as red or yellow flash. The system includes a receiver with retention arms that secure the lateral edges of the substrate. When inserted, the tabs fit into the receiver, engaging the conductive traces with contacts to electrically configure the traffic signal mode. This design facilitates easy insertion, removal, and visual verification of the traffic signal configuration.

### CROSS-REFERENCE TO RELATED APPLICATIONS

This application claims benefit of priority with U.S. Provisional Application Ser. No. 63/745,311, filed Jan. 14, 2025; the entire contents of which are hereby incorporated by reference.

### BACKGROUND

### Field of the Invention

This disclosure relates to a flash program block of a traffic signal cabinet, and more particularly to a flash program block comprising a planar substrate for easier insertion and removal.

### Description of the Related Art

In the United States, each signalized intersection is equipped with a traffic signal cabinet enclosure, typically installed at one of the intersection corners. This cabinet houses essential components such as detectors, controller timers, signal control switches, and a cabinet monitor unit (CMU), which are responsible for controlling the LED signal lamps and ensuring the safe and efficient flow of traffic. These cabinets are critical for maintaining order on the roads, enabling vehicles and pedestrians to move safely through intersections.

Traffic signal cabinets are built and deployed in accordance with a range of standards and specifications, which ensure their reliability, uniformity, and safety. Several key standards govern the design, operation, and installation of these systems including Advanced Transportation Controller (ATC) Cabinet Standard, the Intelligent Transportation System (ITS) Cabinet Standard, the Transportation Electrical Equipment Specifications (TEES), and the NEMA Standard.

Traffic signal cabinets operate in several distinct modes, each serving a specific purpose. In Signal Mode, the controller timer commands the LED signal lamps, allowing for the regular cycling of red, yellow, and green signals. Flash Mode is another operational state where the flasher unit commands only the red LED signal lamps to flash, while the yellow and green signals, along with pedestrian indicators, remain dark. Flash Mode is often employed when there is a fault or when manually selected by the operator, such as during a special event like a football game or street parade. In Dark Mode, the system experiences a power outage with no emergency power backup, causing all LED signal lamps and pedestrian indicators to remain dark.

Except for NEMA standards, all other specifications require that, during Flash Mode, the operator must have the option to select which color of the LED signal lamp (either red or yellow) should flash for any given direction. Additionally, the traffic signal cabinet must also be capable of keeping the pedestrian indicators functional during Flash Mode. To comply with these requirements, manufacturers have developed an adapter known as the Flash Program Block (FPB). The FPB is available in three versions: FPB-Red, which causes the red LED signal lamps to flash during Flash Mode; FPB-Yellow, which causes the yellow LED signal lamps to flash; and FPB-White, which keeps the pedestrian indicator operational during Flash Mode.

Despite the widespread use of FPBs, several issues have arisen concerning their design and manufacturing. The connector housing used in FPBs, which consists of a receptacle and plug, is sourced from a single manufacturer, creating a dependency on a sole supplier. This dependency poses a significant risk if the manufacturer announces the end-of-life of the parts, which could disrupt the availability of FPBs. Furthermore, users have reported difficulties in removing FPBs, sometimes requiring the use of tools to extract the adapter. This process can lead to damage to the printed circuit board (PCB), the FPB's pins, or even cause the pulling of wires, thereby compromising the functionality of the traffic signal system. Additionally, the manufacturing of FPBs requires the procurement of specialized materials such as wire with specific gauges and jacket colors, special pins for the receptacle and plug, and specific connector housings. The production process also involves the use of wire cutting and stripping machines, crimping machines, and additional steps for assembly, quality control, and testing.

Since the introduction of the FPB in January 1989, the design has remained largely unchanged, and there has been little modernization in the manufacturing processes. As a result, these adapters are becoming outdated, and the manufacturing methods are increasingly inefficient. These issues underline the need for an improved design and updated manufacturing techniques for FPBs, addressing both technical limitations and the need to streamline production processes to meet the demands of modern traffic signal systems.

### SUMMARY

The invention relates to an improved flash program block (IFPB) used in traffic signal cabinets to facilitate the configuration of traffic signal modes. The IFPB comprises a planar substrate made from dielectric material, with a top edge that includes a mode indicator to visually inform technicians of the selected signal mode. The IFPB features conductive traces that engage with contacts in a flash program block receiver, enabling the selection of red, yellow, or white signal configurations. This design provides a more reliable and flexible solution for adapting to different operational states of the traffic signal system, such as during faults, special events, or routine signal operation. The IFPB can be easily inserted and removed from the receiver, ensuring efficient maintenance and replacement without requiring excessive force. The IFPB and the flash program block receiver can be utilized in a field output terminal assembly that integrates high-density flash transfer relays and load terminal block receptacles.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows conventional flash program blocks;

FIG. 2 shows a perspective view of an improved flash program block in accordance with a first illustrated embodiment;

FIG. 3 shows a front plane view of the improved flash program block according to the first illustrated embodiment;

FIG. 4 shows a side view of the improved flash program block according to the first illustrated embodiment;

FIG. 5 shows a perspective view of a flash program block receiver according to the first illustrated embodiment;

FIG. 6 shows a front view of the improved flash program block partially inserted into the flash program block receiver according to the first illustrated embodiment;

FIG. 7 shows a front view of the improved flash program block fully inserted into the flash program block receiver according to the first illustrated embodiment; and

FIG. 8 shows a block diagram of a field output terminal assembly comprising the improved flash program block and the flash program block receiver in accordance with a second illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

The features, components, and configurations described in connection with the various embodiments illustrated herein may be combined, interchanged, or otherwise modified in any number of ways without departing from the scope and spirit of the invention. The embodiments are presented by way of example and not limitation, and it is intended that the invention encompasses all such combinations, permutations, and modifications as would be understood by those skilled in the art.

For purposes herein, the term “FPB” means “flash program block”.

The term “width” used herein refers to a dimension measured along an axis extending from the first lateral edge to the second lateral edge.

Unless explicitly defined herein, terms are to be construed in accordance with the plain and ordinary meaning as would be appreciated by one having skill in the art.

### General Description of Embodiments

In a general embodiment, an improved flash program block is disclosed. The improved flash program block may comprise a planar substrate, the planar substrate comprising a top surface, a bottom surface opposite the top surface, and a plurality of edges extending from the top surface to the bottom surface. The plurality of edges may comprise a top edge, a bottom edge, a first lateral edge, and a second lateral edge, with the planar substrate further comprising a substrate width extending from the first lateral edge to the second lateral edge. The improved flash program block may further comprise one or more tabs extending from the bottom edge, the one or more tabs comprising a tab width less than the substrate width. Additionally, a plurality of conductive traces may be disposed on the one or more tabs, wherein each of the one or more tabs may comprise at least one of the plurality of conductive traces. A mode indicator may be disposed on the top edge of the planar substrate.

In some embodiments, the planar substrate may comprise a dielectric material.

In some embodiments, the mode indicator may further comprise a color indicator.

In some embodiments, the one or more tabs may comprise a coplanar relationship with the planar substrate.

In some embodiments, the one or more tabs may further comprise a first tab and a second tab.

In some embodiments, the second tab may comprise a tab width greater than the first tab.

In some embodiments, the improved flash program block may further comprise a spacing between the first tab and the second tab.

In some embodiments, the spacing may extend into a portion of the bottom edge.

In some embodiments, the plurality of conductive traces may comprise a first conductive trace, a second conductive trace, and a third conductive trace, wherein the first tab may comprise the first conductive trace, and the second tab may comprise the second conductive trace and the third conductive trace.

In another general embodiment, a subsystem in a traffic signal cabinet is disclosed. The subsystem may comprise an improved flash program block. The improved flash program block may comprise a planar substrate, the planar substrate comprising a top surface, a bottom surface opposite the top surface, and a plurality of edges extending from the top surface to the bottom surface. The plurality of edges may comprise a top edge, a bottom edge, a first lateral edge, and a second lateral edge, the planar substrate further comprising a substrate width extending from the first lateral edge to the second lateral edge. The improved flash program block may further comprise one or more tabs extending from the bottom edge, the one or more tabs comprising a tab width less than the substrate width. A plurality of conductive traces may be disposed on the one or more tabs wherein each of the one or more tabs comprises at least one of the plurality of conductive traces. A mode indicator may be disposed on the top edge of the planar substrate. The subsystem may further comprise a flash program block receiver. The receiver may comprise a body having an upper side and a lower side. A first retention arm and a second retention arm may each extend from the upper side, wherein the first retention arm and the second retention arm may each comprise a channel to engage one of the first lateral edge or the second lateral edge. A gap may be disposed between the first retention arm and the second retention arm, the gap configured to receive the improved flash program block. Contacts may be disposed at the upper side between the first retention arm and the second retention arm, the contacts configured to electrically connect with the plurality of conductive traces of the flash program block.

In some embodiments, the improved flash program block receiver may further comprise pins disposed at the lower side of the body, wherein the pins may be fixedly coupled to a field output terminal assembly.

In some embodiments, the gap may comprise a width less than the substrate width.

In some embodiments, the first retention arm and the second retention arm may be pivotally coupled to the body such that the first retention arm and the second retention arm may be configured to pivot away from the gap.

In some embodiments, the planar substrate may comprise a dielectric material.

In some embodiments, the mode indicator may further comprise a color indicator.

In some embodiments, the one or more tabs may comprise a coplanar relationship with the planar substrate.

In some embodiments, the one or more tabs may further comprise a first tab and a second tab.

In some embodiments, the second tab may comprise a tab width greater than the first tab.

In some embodiments, the subsystem may further comprise a spacing between the first tab and the second tab.

In some embodiments, the spacing may extend into a portion of the bottom edge.

In another general embodiment, a method of changing a traffic signal mode in a traffic signal cabinet is disclosed. The method may comprise providing a flash program block receiver having a first retention arm, a second retention arm, and a plurality of contacts disposed between the first retention arm and the second retention arm, the flash program block receiver electrically coupled to a field output terminal assembly. The method may further comprise receiving an improved flash program block into a gap defined between the first retention arm and the second retention arm of the flash program block receiver, the improved flash program block comprising a planar substrate, the planar substrate having a top edge, a bottom edge, and one or more tabs extending from the bottom edge. The method may also comprise securing a first lateral edge and a second lateral edge of the planar substrate within channels of the first retention arm and the second retention arm, respectively. Furthermore, the method may comprise engaging a plurality of conductive traces disposed on the one or more tabs with the plurality of contacts of the flash program block receiver to establish an electrical connection. The method may conclude by configuring the traffic signal cabinet to operate in a specific flash mode based on said improved flash program block received.

In some embodiments, the improved flash program block may further comprise a mode indicator disposed on the top edge of the improved flash program block, wherein the mode indicator may correspond to the specific flash mode the traffic signal cabinet is configured into.

In some embodiments, securing the first lateral edge and the second lateral edge may comprise rotating the first retention arm and the second retention arm, respectively.

Each of the components of the IFPB related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### Illustrated Embodiments

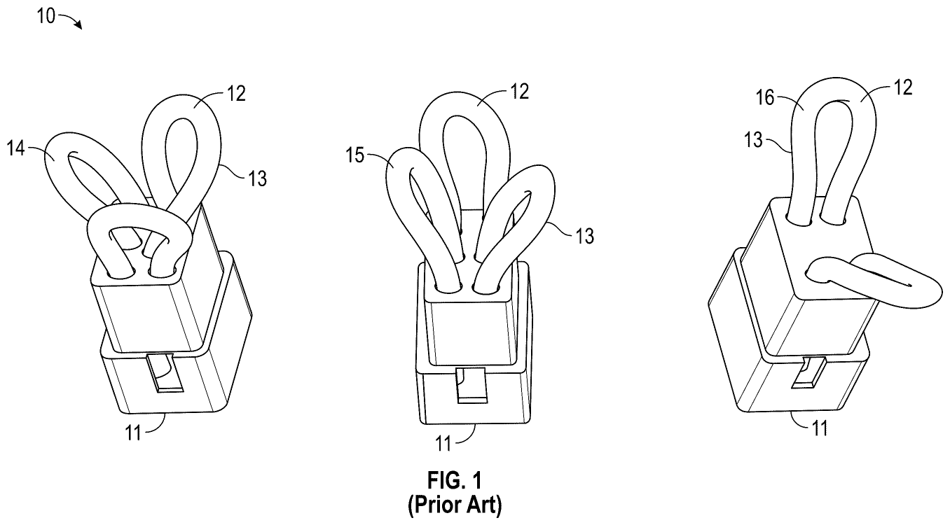

Now turning to the drawings, FIG. 1 shows a conventional FPB (10), which comprises several key components and features, including a socket (11) and a wiring assembly (12). These components work together to allow the FPB to interface with a traffic signal cabinet and enable different operational modes for the signal lights. The FPB comprises a socket (11) that is designed to accommodate a wiring assembly (12), which is an integral part of the device. The wiring assembly includes a mode indicator (13) being a color indicator that designates the specific mode for which the FPB is configured. This mode indicator is a crucial feature, as it provides technicians with clear information about the operational configuration of the FPB. The wiring assembly dictates the mode configuration by determining the appropriate electrical pathways for the selected mode. The configuration of the FPB can be chosen based on the needs of the intersection and can include various operational states such as Red, Yellow, or White, depending on the mode selection.

As shown in the figure, the FPB (10) includes three distinct mode configurations. These configurations are the red mode configuration (14), the yellow mode configuration (15), and the white mode configuration (16). Each of these configurations is associated with a specific function within the traffic signal cabinet. The red mode configuration is used to flash the red LED signal lamps during Flash Mode, the yellow mode configuration is used to flash the yellow LED signal lamps, and the white mode configuration is designed to maintain the pedestrian indicator active during Flash Mode, ensuring that pedestrian safety is not compromised during traffic signal failures.

The flash program block (10) allows for the selection of different color modes for any direction of the lights controlled by the traffic signal cabinet. This feature is critical in ensuring that the traffic signal system can be customized to meet the specific needs of an intersection during various scenarios, such as special events or traffic congestion. By enabling the operator to select which light (Red or Yellow) should flash, the FPB provides the flexibility needed to adapt to different operational conditions.

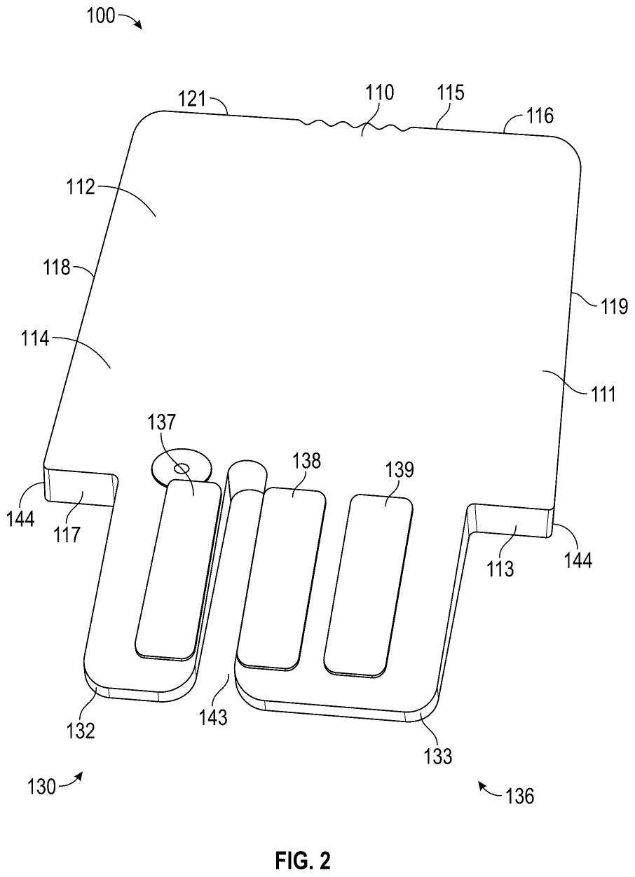

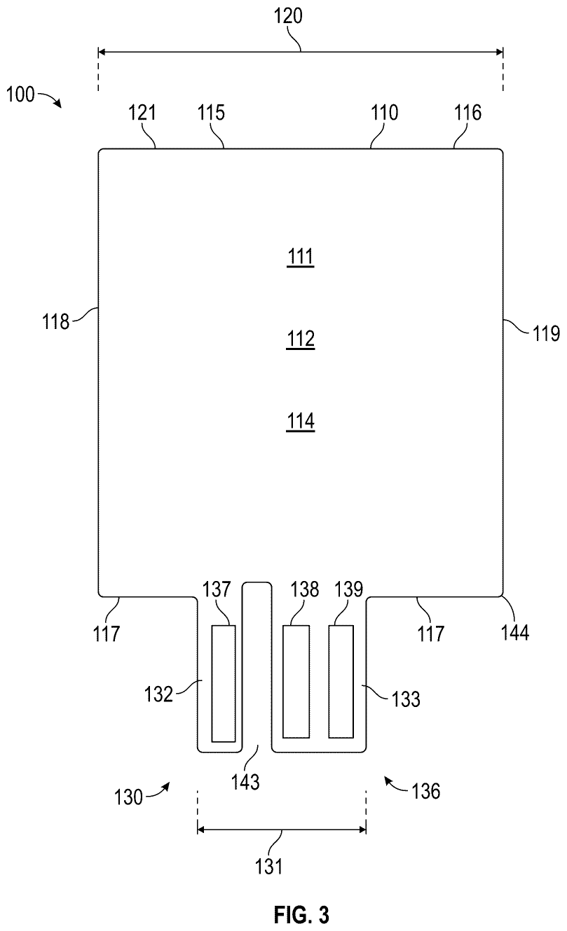

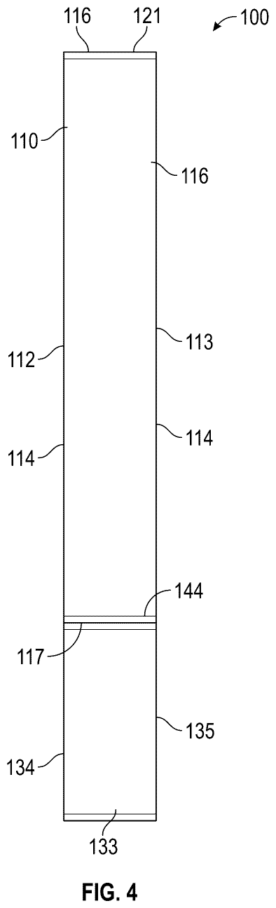

FIG. 2-4 show an improved flash program block (IFPB) (100) in accordance with a first illustrated embodiment. The IFPB comprises a planar substrate (110) made from dielectric material (111), which serves as the main structural element of the device. The planar substrate is characterized by a top surface (112) and a bottom surface (113) that are both flat planes (114), ensuring stability and uniformity in the electrical connections.

The planar substrate (110) has a plurality of edges (115), which includes a top edge (116), a bottom edge (117), a first lateral edge (118), and a second lateral edge (119). The planar substrate further comprises a substrate width (120) extending from the first lateral edge to the second lateral edge. The top edge (116) may comprise a mode indicator (121), such as a color indicator, that informs a technician of the mode configuration the IFPB is designed for. The mode indicator provides visual information, often in the form of a color (such as red, yellow, or white) or words, to designate the particular mode of operation. This can ensure a correct setup and use of the traffic signal system.

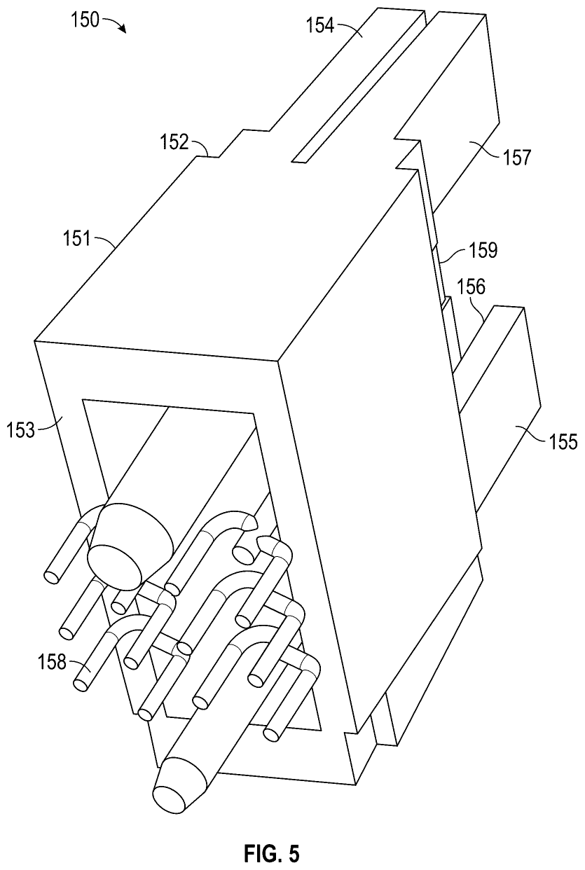

The IFPB (100) also includes a plurality of tabs (130) extending from the bottom edge (117) of the planar substrate (110). The plurality of tabs establishes an electrical connection with an FPB receiver (FIG. 5; 150). The plurality of tabs comprises a tab width (131) that is less than the substrate width (120), allowing the tabs to properly fit within the receiver. As shown, the plurality of tabs comprises a first tab (132) and a second tab (133). In other embodiments, the planar substrate may comprise a single tab.

Each of the plurality of tabs comprises at least one of a plurality of conductive traces (136) that provide the desired electrical connections. The plurality of traces includes a first conductive trace (137), a second conductive trace (138) and a third conductive trace (139). The first conductive trace is located on the first tab, while the second conductive trace and third conductive trace are located on the second tab. These traces are designed to engage with the contacts from the FPB receiver (FIG. 5; 150), establishing the specific mode configuration based on the electrical pathway disposed on the planar substrate (110). The traces are part of the IFPB's mechanism for enabling the mode selection process, which determines the operational state of the traffic signal system.

A spacing (143) is disposed between the first tab (132) and the second tab (133), further extending into a portion of the bottom edge (117) of the planar substrate (110). Due to the spacing, the second tab comprises a greater width than the first tab. This spacing ensures that the tabs are correctly positioned within the receiver to maintain proper alignment and secure electrical engagement with the receiver's contacts. The plurality of tabs comprises a same length, allowing them to concurrently engage with the contacts of the FPB receiver (FIG. 5; 150).

The planar substrate (110) further comprises stabilizing corners (144) at the junctions of the bottom edge (117) with both the first and second lateral edges (118; 119). These stabilizing corners are configured to engage with the FPB receiver (FIG. 5; 150), providing a secure hold and ensuring that the IFPB (100) remains firmly in place during operation.

FIG. 5 shows a flash program block receiver (“FPB receiver”) (150) according to the first illustrated embodiment. The FPB receiver is used to secure and electrically interface with the IFPB (100). The receiver is designed to engage with and provide electrical connections for the IFPB, allowing for the selection of different modes for the traffic signal system. The FPB receiver comprises a body (151) having an upper side (152) and a lower side (153), which are opposite each other and define the orientation of the receiver. The FPB receiver further comprises a first retention arm (154) and a second retention arm (155), both extending from the upper side. The lower side comprises pins (158) for fixed coupling to a corresponding field output terminal assembly. The first and second retention arms provide secure holding of the IFPB. The retention arms each comprise a channel (156) that is specifically designed to receive and hold the lateral edges of the IFPB. This ensures that the IFPB remains firmly positioned during operation.

A gap (157) is formed between the first and second retention arms (154; 155). This gap is the space into which the IFPB (100) is inserted. The gap is narrower than the substrate width (120) of the planar substrate (110), which allows the retention arms to securely grip the edges of the planar substrate. Once the IFPB is inserted, the retention arms hold the planar substrate in place, preventing it from becoming dislodged during use.

On the upper side of the FPB receiver (150), disposed between the first and second retention arms (154; 155), are contacts (159) that are configured to electrically engage with the conductive traces (136) of the IFPB (100). These traces establish the particular mode configuration for the traffic signal system, determining which signal light will flash in response to the selected operational state.

In some embodiments, the first and second retention arms (154; 155) may be configured to pivot away from the gap (157), creating an open state for easier insertion of the IFPB (100). This design feature allows for simple and convenient installation without requiring excessive force. Once the IFPB is inserted, the retention arms return to their closed state, securely holding the IFPB in place.

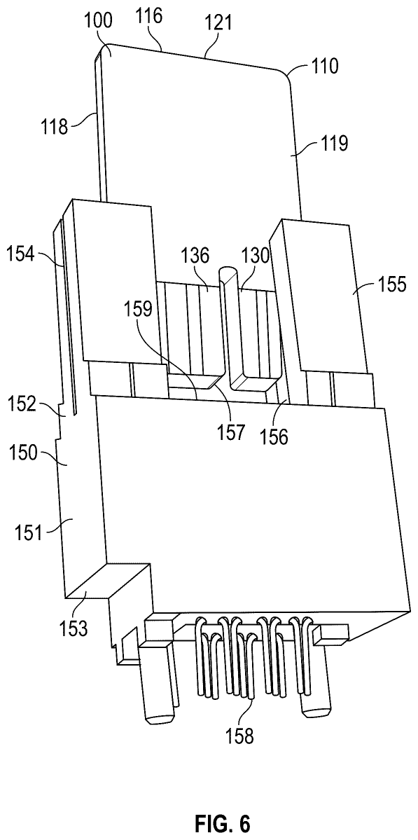

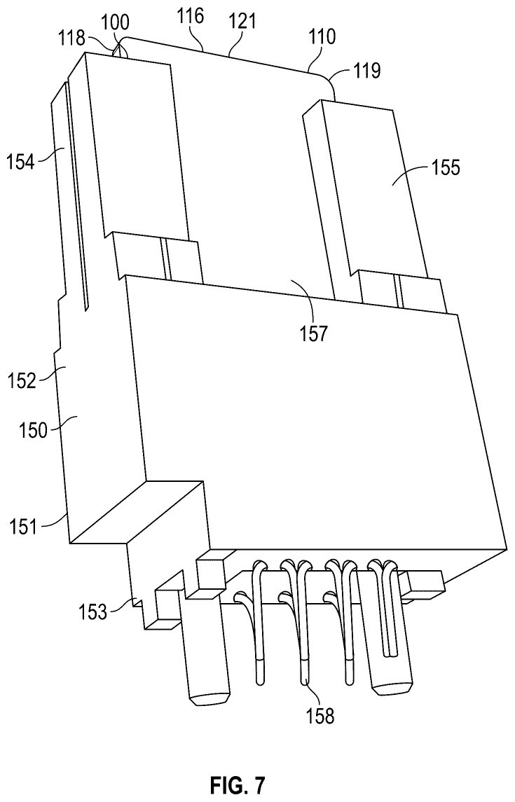

FIG. 6-7 shows a IFPB (100) partially and fully inserted into an FPB receiver (150) The FPB receiver comprises a body (151) having an upper side (152) and a lower side (153) opposite the upper side. The upper side includes a first retention arm (154) and a second retention arm (155) for securing the IFPB. The lower side comprises pins (158) that facilitate the coupling of the FPB receiver to a field output terminal assembly, ensuring electrical connections for mode configuration.

Each of the first and second retention arms (154; 155) comprises a channel (156) designed to receive and hold the first lateral edge (118) and the second lateral edge (119) of the planar substrate (110), respectively. The first and second retention arms form a gap (157) between the retention arms. The gap is narrower than the substrate width (120) of the IFPB (100), providing a snug fit for the IFPB's edges and ensuring the device is securely held in place.

Once the IFPB (100) is inserted into the FPB receiver (150), contacts (159) on the upper side of the FPB receiver electrically engage with a plurality of conductive traces (136) on the planar substrate (110) of the IFPB. These traces establish the electrical connections that determine the mode configuration of the traffic signal system.

The interaction between the IFPB (100) and the FPB receiver (150) allows for the configuration of the traffic signal system's mode based on the specific needs of the situation. When the IFPB is inserted into the FPB receiver, the top edge (116) of the planar substrate (110) is exposed to the technician, making it easy to visually confirm the mode configuration. This mode configuration is indicated by the mode indicator (121) on the top edge, which can display the selected mode, such as red, yellow, or white, depending on the needs of the intersection.

The IFPB (100) is designed to detachably engage with the FPB receiver (150). This detachment allows for easy maintenance and replacement of the IFPB without requiring excessive force or complex procedures. The stabilizing corners (144) on the FPB provide further security when the device is engaged with the receiver, preventing misalignment and ensuring stable operation.

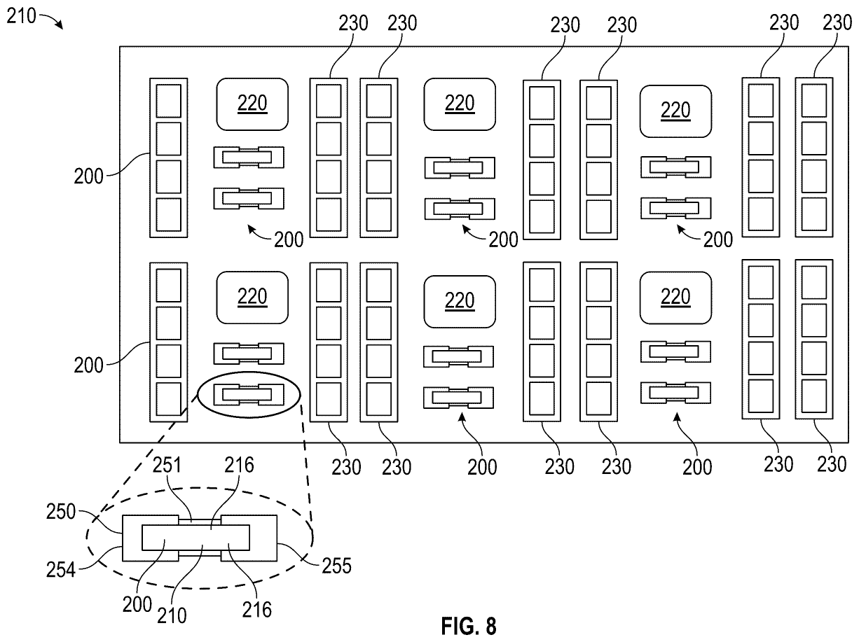

FIG. 8 illustrates a field output terminal assembly (210) that includes the improved flash program block (IFPB) (200), the FPB receiver (250), along with high-density flash transfer relays (220) and load terminal block receptacles (230). The FPB receiver forms a critical part of the field output terminal assembly (210). It is designed to securely hold the IFPB and establish the necessary electrical connections for mode lighting selection. The FPB receiver includes a body (251) having a first retention arm (254) and a second retention arm (255). The top edge (216) of the planar substrate (210) of the IFPB comprises a mode indicator (221) configured to remain visible when the IFPB is inserted into the FPB receiver. The mode indicator designates one of a plurality of lighting modes for the traffic signal cabinet. This allows a technician to easily determine the current mode of operation, such as red, yellow, or white, and make adjustments as necessary.

### FEATURE LIST

flash program block (10)
socket (11)
wiring assembly (12)
red mode configuration (14)
yellow mode configuration (15)
white mode configuration (16)
improved flash program block (100; 200)
planar substrate (110; 210)
dielectric material (111)
top surface (112)
bottom surface (113)
flat plane (114)
plurality of edges (115)
top edge (116; 216)
bottom edge (117)
first lateral edge (118)
second lateral edge (119)
substrate width (120)
mode indicator (13; 121)
plurality of tabs (130)
tab width (131)
first tab (132)
second tab (133)
top side (134)
bottom side (135)
plurality of conductive traces (136)
first conductive trace (137)
second conductive trace (138)
third conductive trace (139)
spacing (143)
stabilizing corners (144)
flash program block receiver (150; 250)
body (151; 251)
upper side (152)
lower side (153)
first retention arm (154; 254)
second retention arm (155; 255)
channel (156)
gap (157)
pins (158)
contacts (159)
field output terminal assembly (210)
high-density flash transfer relay (220)
load terminal block receptacle (230)

What is claimed is:

1. An improved flash program block, comprising:
a planar substrate, the planar substrate comprising a top surface, a bottom surface opposite the top surface, and a plurality of edges extending from the top surface to the bottom surface, the plurality of edges comprising a top edge, a bottom edge, a first lateral edge, and a second lateral edge, the planar substrate further comprising a substrate width extending from the first lateral edge to the second lateral edge;
one or more tabs extending from the bottom edge, the one or more tabs comprising a tab width less than the substrate width;
a plurality of conductive traces disposed on the one or more tabs wherein each of the one or more tabs comprises at least one of the plurality of conductive traces; and
a mode indicator disposed on the top edge of the planar substrate.

2. The improved flash program block of claim 1, wherein the planar substrate comprises a dielectric material.

3. The improved flash program block of claim 1, the mode indicator further comprising a color indicator.

4. The improved flash program block of claim 1, wherein the one or more tabs comprises a coplanar relationship with the planar substrate.

5. The improved flash program block of claim 1, the one or more tabs further comprising a first tab and a second tab.

6. The improved flash program block of claim 5, wherein the second tab comprises a tab width greater than the first tab.

7. The improved flash program block of claim 5, further comprising a spacing between the first tab and the second tab.

8. The improved flash program block of claim 7, wherein the spacing extends into a portion of the bottom edge.

9. The improved flash program block of claim 5, the plurality of conductive traces comprising a first conductive trace, a second conductive trace, and a third conductive trace, wherein the first tab comprises the first conductive trace, and the second tab comprises the second conductive trace and the third conductive trace.

10. A subsystem in a traffic signal cabinet, comprising:
an improved flash program block, comprising:
a planar substrate, the planar substrate comprising a top surface, a bottom surface opposite the top surface, and a plurality of edges extending from the top surface to the bottom surface, the plurality of edges comprising a top edge, a bottom edge, a first lateral edge, and a second lateral edge, the planar substrate further comprising a substrate width extending from the first lateral edge to the second lateral edge,
one or more tabs extending from the bottom edge, the one or more tabs comprising a tab width less than the substrate width,
a plurality of conductive traces disposed on the one or more tabs wherein each of the one or more tabs comprises at least one of the plurality of conductive traces, and
a mode indicator disposed on the top edge of the planar substrate; and
a flash program block receiver, comprising:
a body having an upper side and a lower side,
a first retention arm and a second retention arm each extending from the upper side, the first retention arm and the second retention arm each comprises a channel to engage one of the first lateral edge or the second lateral edge,
a gap disposed between the first retention arm and the second retention arm, the gap configured to receive the improved flash program block, and
contacts disposed at the upper side between the first retention arm and the second retention arm, the contacts configured to electrically connected with the plurality of conductive traces of the flash program block.

11. The subsystem of claim 10, the improved flash program block receiver further comprising pins disposed at the lower side of the body, wherein the pins fixedly coupled to a field output terminal assembly.

12. The subsystem of claim 10, wherein the gap comprises a width less than the substrate width.

13. The subsystem of claim 10, wherein the first retention arm and the second retention arm are pivotally coupled to the body such that the first retention arm and the second retention arm are configured to pivot away from the gap.

14. The subsystem of claim 10, the mode indicator further comprising a color indicator.

15. The subsystem of claim 10, the one or more tabs further comprising a first tab and a second tab.

16. The subsystem of claim 15, further comprising a spacing between the first tab and the second tab.

17. The subsystem of claim 16, wherein the spacing extends into a portion of the bottom edge.

18. A method of changing a traffic signal mode in a traffic signal cabinet, the method comprising:
providing a flash program block receiver a first retention arm, a second retention arm, and a plurality of contacts disposed between the first retention arm and the second retention arm, the flash program block receiver electrically coupled to a field output terminal assembly;
receiving an improved flash program block into a gap defined between the first retention arm and the second retention arm of the flash program block receiver, the improved flash program bock comprising a planar substrate, the planar substrate having a top edge, a bottom edge, and one or more tabs extending from the bottom edge;
securing a first lateral edge and a second lateral edge of the planar substate within channels of the first retention arm and the second retention arm, respectively; and
engaging a plurality of conductive traces disposed on the one or more of tabs with the plurality of contacts of the flash program block receiver to establish an electrical connection; and
configuring the traffic signal cabinet to operate in a specific flash mode based on said improved flash program block received.

19. The method of claim 18, the improved flash program block further comprising a mode indicator disposed on the top edge of the improved flash program block, wherein the mode indicator corresponds to the specific flash mode the traffic signal cabinet is configured into.

20. The method of claim 18, wherein securing the first lateral edge and the second lateral edge comprises rotating the first retention arm and the second retention arm, respectively.
